(19) United States
(12) Patent Application Publication
(10) Pub. No.: US 2024/0118534 A1
(43) Pub. Date: Apr. 11, 2024

(54) OPTICAL SCANNING ELEMENT SUBMERGED IN LIGHT-TRANSMISSIVE FLUID

(71) Applicant: Veoneer US, LLC, Southfield, MI (US)

(72) Inventor: Bernard de Mersseman, Lowell, MA (US)

(73) Assignee: Veoneer US, INC., Southfield, MI (US)

(21) Appl. No.: 17/961,626

(22) Filed: Oct. 7, 2022

(51) Int. Cl. G02B 26/00; G01S 7/481; G02B 26/10

(52) U.S. Cl. CPC G02B 26/004; G01S 7/4817; G02B 26/10; G01S 17/931

(57) ABSTRACT

An example system includes a movable optical element configured to direct light along an optical path, a flat surface along the optical path, where the light from the movable optical element passes through the flat surface to an external environment, and a light-transmissive fluid that is present along the optical path. The light-transmissive fluid and the flat surface have a substantially same optical index.

### TECHNICAL FIELD

This specification describes examples of detection techniques that use an optical scanning element submerged, at least partly, in light-transmissive fluid.

### BACKGROUND

Vehicles may benefit from having detection systems that obtain information about information in the vehicle's environment. For example, detection systems often obtain information such as bearing, range, velocity, reflectivity, and image data for objects within the vehicle's environment. Such detection systems can be used for collision avoidance, self-driving, cruise control, and the like.

### SUMMARY

An example system includes a movable optical element configured to direct light along an optical path, a flat surface along the optical path, where the light from the movable optical element passes through the flat surface to an external environment, and a light-transmissive fluid that is present along the optical path. The light-transmissive fluid and the flat surface have a substantially same optical index. The system may include one or more of the following features, either alone or in combination.

The system may include a light source to emit the light and one or more static optical element to direct the light along an initial optical path. The movable optical element may be configured to receive the light from the initial optical path and to redirect the light along optical path. The external environment may have an optical index that is less than the optical index of the light-transmissive fluid and the flat surface. The movable optical element may have an optical index that is greater than the optical index of the light-transmissive fluid and the flat surface. The movable optical element may have an optical index that is 0.4 or more greater than the optical index of the light-transmissive fluid and the flat surface. The light-transmissive fluid may be, or include, oil. The light-transmissive fluid may be, or include, silicon oil. The light-transmissive fluid may have a light transmissibility of 95% or more. The flat surface may be, or include, glass. The flat surface may include at least one of polycarbonate, polymer, or clear acrylic.

The movable optical element may include an optical scanning element having a glass body in the shape of a rectangular prism. The optical scanning element may be configured to rotate around an axis. The optical scanning element may include a reflective member having opposing reflective surfaces within the glass body. The optical scanning element may include one or more magnets. The system may include coils that are controllable to generate one or more magnetic fields that interact with the one or more magnets to control rotation of the optical scanning element. The movable optical element may be configured to receive the light from an initial optical path at a first side thereof and to redirect the light along the optical path from a second side thereof. The first side may be behind the second side.

The system may be part of a light detection and ranging (LIDAR) system for a vehicle. The LIAR system may be configured for use in at least one of: automatic emergency breaking for the vehicle, forward sensing for the vehicle, or automated driving for the vehicle. The flat surface may include an anti-reflective coating. The movable optical element may be completely submerged in the light-transmissive fluid. The movable optical element may be partially submerged in the light-transmissive fluid. The movable optical element may be configured to direct light along multiple optical paths. The light-transmissive fluid may be present along the multiple optical paths. The external environment may include air.

Any two or more of the features described in this specification, including in this summary section, may be combined to form implementations not specifically described in this specification.

The systems, techniques, components, structures, and variations thereof described herein, or portions thereof, can be implemented using, or controlled by, a computer program product that includes instructions that are stored on one or more non-transitory machine-readable storage media, and that are executable on one or more processing devices to execute at least some of the operations described herein. The systems, techniques, components, structures, and variations thereof described herein, or portions thereof, can be implemented as an apparatus, method, or electronic system that can include one or more processing devices and computer memory to store executable instructions to implement various operations. The systems, techniques, components, structures, and variations thereof described herein may be configured, for example, through design, construction, size, shape, arrangement, placement, programming, operation, activation, deactivation, and/or control.

The details of one or more implementations are set forth in the accompanying drawings and the following description. Other features and advantages will be apparent from the description and drawings, and from the claims.

### DESCRIPTION OF THE DRAWINGS

FIG. 1 is view of a front end of an example automobile.

FIG. 2 is a block diagram containing components of an example scanning system and an associated control system.

FIG. 3 is a top view of an example optical scanning element within an enclosure containing light-transmissive fluid, and of light beams passing therethrough.

FIG. 4 is a side view of the example optical scanning element within the enclosure, which also shows mechanical connections for rotation.

FIG. 5 is perspective view of components of the example scanning system.

FIGS. 6A and 6B are front and bottom perspective views, respectively, of an example optical scanning element.

FIGS. 7A, 78, and 7C are top views of the example scanning system showing light scanned at three different angles using the optical scanning element.

FIGS. 8A, 8B, and 8C are side views of the example scanning system showing light scanned at three different angles using the optical scanning element.

Like reference numerals in different figures indicate like elements.

### DETAILED DESCRIPTION

Described herein are example implementations of detecting systems that use movable optical elements to scan a region and to detect objects within that region. A type of system that may be used includes, for example, a light detection and ranging (LIDAR) system to detect one or more objects exterior to the vehicle. LIDAR is a technique for determining ranges (e.g., variable distance) by targeting an object with a laser beam and measuring a time for the reflected light to return to a receiver.

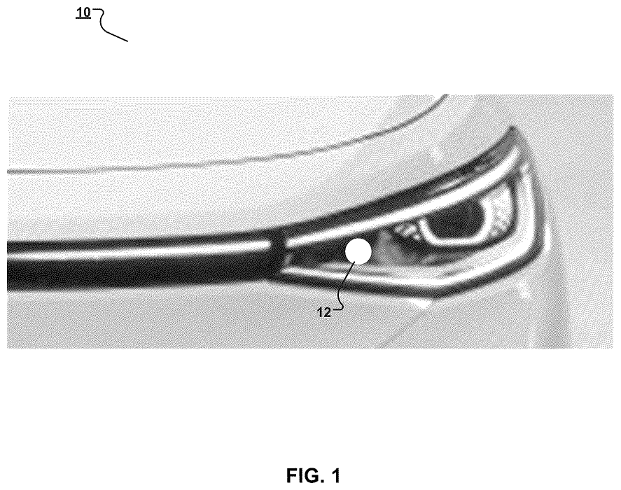

Referring to FIG. 1, the components of an example LIDAR system 12 may be housed in an enclosure on a vehicle, such as automobile 10, FIG. 1 shows LIDAR system 12 on the vehicle's front-end; however, it may be located elsewhere on the automobile. The components include a movable optical element, such as the optical scanning element described below, to move a laser beam within the environment external to the automobile. The enclosure may include a substantially flat window through which light, such as laser light, exits and enters the enclosure. The flatness of the window may enhance the aesthetics of the automobile and may be easier to wash. Therefore, it is typically a desirable feature. However, due to differences in the optical index of the flat window and air, undesirable reflections of laser light may occur at the air/window interface, which may adversely affect the operation of the LIDAR system. For example, for azimuth angles greater than ±65° from a center point, reflective losses may be greater than 10% in some cases. Accordingly, the systems described herein introduce a light-transmissive fluid (e.g., having a clarity of 95% or more), such as silicon oil, along the optical path between the movable optical element and the flat window. The light-transmissive fluid has a substantially same optical index as the flat window. As a result, there may be fewer reflections of the infrared light off of the flat window, which may improve operation of the LIDAR system. Adding an anti-reflective coating to the flat window may further reduce reflections at the air/window interface.

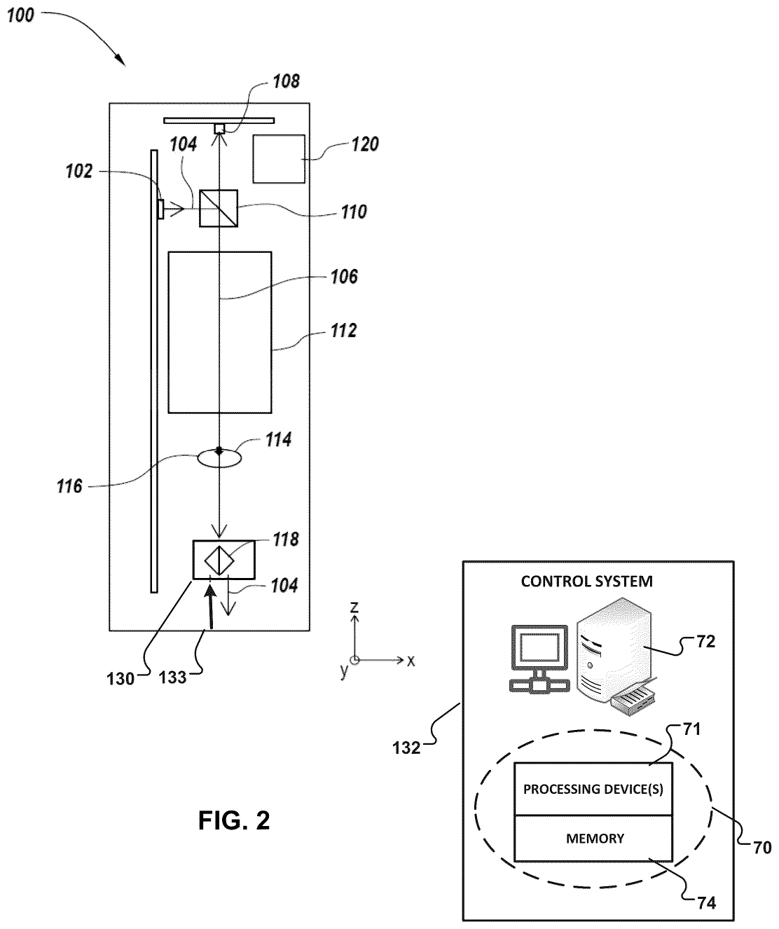

FIG. 2 shows an example implementation of a LIDAR detection system 100 of the type described previously. System 100 can be mounted on or within the body of a vehicle, such as automobile 10, and can be used generally to obtain information and generate data about the vehicle's environment. The detection system 100 includes at least one LIDAR transmitter 102 configured to transmit a light beam 104 along an optical path 106. The LIDAR transmitter 102 includes an emitter of optical radiation, such as an array of laser diodes configured to generate pulsed lasers or light beams 104 for reflection off objects within the environment (not shown, but generally around the detection system and associated vehicle). The light beams 104 transmitted by the LIDAR transmitters 102 can be infrared, and/or near infrared light, for example, to avoid distracting or otherwise effecting the visibility of other drivers. The infrared light may having wavelengths in the range of about 700 nanometers (nm) to 1 millimeter (mm). NIR light is generally considered to be in the range of 700 nm to 2500 nm. In a particular example, the infrared light has a wavelength of about 940 nm.

After reflecting off an object within the environment, a light beam 133 returns along the optical path 106 for receipt by at least one LIDAR receiver 108. The LIDAR receiver 108 may include an optical detection device. This implementation of detection system 100 uses a single LIDAR transmitter and LIDAR receiver. However, in some cases, multiple LIDAR transmitters and receivers may be included to improve resolution. When multiple LIDAR transmitters and receivers are included, they can be arranged in a column or array to transmit and receive multiple light beams 104, 133, respectively. A control module 120, which may be part of control system 132 (described below), may process and store data related to the range and position of objects within the environment based on the received signals.

The optical path 106 of the light beams is shared by the LIDAR transmitter 102 and LIDAR receiver 108. In optical path 106, a beam splitter 110 is used to account for the offset LIDAR transmitter 102 and receiver 108. The beam splitter 110 may be a polarized beam splitter that redirects initially-transmitted light beams 104 along the optical path 106, while allowing returning light beams to pass therethrough for receipt by the LIDAR receivers 108. A collimating lens 112 focuses transmitted light beams 104, which are then directed to a reflective mirror 114. Elements 102, 104, 108, 110, and 112 may be static, in that they do not move during LIDAR scanning. During scanning, reflective mirror 114 moves such that the orientation of its reflective surface 116 changes with respect to the elevation direction (e.g., changing the deflection angle along the “y” axis). Movement of mirror 114 may be controlled using a motor (not shown) that is controlled by control system 132. Through movement, such as an oscillation of the reflective surface, the reflective mirror 114 redirects the ultimate path of the light beam 104 in the elevation direction. From the reflective mirror 114, the light beams 104 are redirected to an example optical scanning element 118.

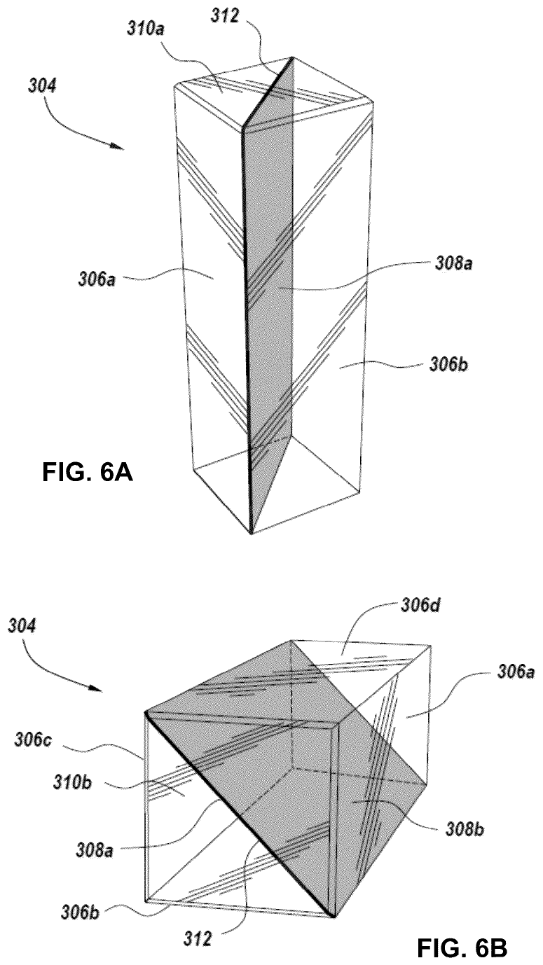

While the properties of the optical scanning element 118 are discussed in greater detail below with respect to FIGS. 6A and 6B, the optical scanning element 118 includes a reflective surface within a glass body in the shape of a rectangular prism. During a scanning cycle, the optical scanning element 118 is configured to move or rotate around an axis to redirect the light beam 104 for scanning the environment. The optical scanning element 118 can be affixed to rotate around the “y” axis to scan the azimuth direction (e.g., changing field of view along the x-z plane) and can continuously rotate in full, 360 degree, rotations during the scanning cycle, or can oscillate at a predetermined cycle time. Movement of optical scanning element 118 may be controlled using a motor (not shown) that may be controlled by the control system 132.

Reflected light 133 returns along substantially the same optical path 106, and that reflected light is redirected by the optical scanning element 118 to the reflective mirror 114 before being redirected through the collimating lens 112. The optical path 106 splits at the beam splitter 110, and the reflected light beams pass through the beam splitter 110 and to the optical receiver 108. Thus, the transmitted light beams 104 and reflected light beams share the same optical path 106 through the lens 112, making the LIDAR transmitter 102 and receiver 108 coaxial. In some cases, the positioning of the LIDAR transmitter 102 and receiver 108 can also be reversed, or otherwise positioned to provide a coaxial system.

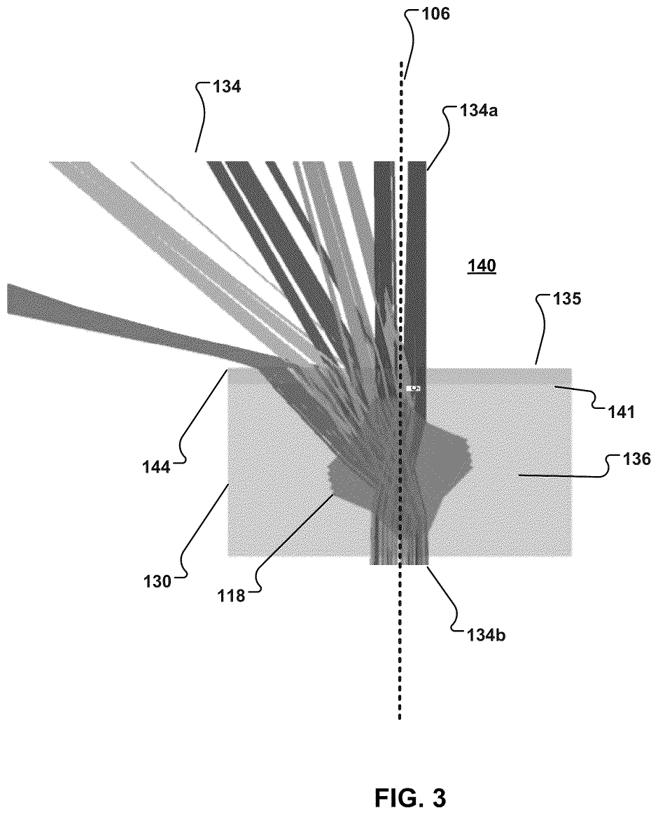

As shown in FIGS. 2 and 3, optical scanning element 118 is contained within a liquid-tight enclosure 130 having a flat window 135 facing the external environment 140. Light 134 directed at different times by optical scanning element 118 and returned (e.g., reflected) from an object in the environment passes through a flat window 135 located in the optical path 106 of the transmitted light and the reflected light. The flat window may made of glass (e.g., N-BK7 borosilicate crown glass) or other clear material such as, but not limited to, clear polycarbonate, clear plastic, clear polymer, or clear acrylic. The flat window is part of liquid-tight enclosure 130 containing at least part of least optical scanning element 118 and, in some implementations, additional components of the system shown in FIG. 2 such as all or part of mirror 114 and all or part of lens 112, In some implementations, the entirety of enclosure 130 is made of clear material—for example, the same material that is used to form flat window 135.

Enclosure 130 contains a light-transmissive fluid 136. In some implementations, the part of the optical scanning element 118 that directs light is completely submerged in the light-transmissive fluid; and, in some implementations, the entirety of the optical scanning element 118 is completely submerged in the light-transmissive fluid. In either case, optical scanning element 118 is submerged in a manner that still enables the movements described herein to perform scanning. Furthermore, the light-transmissive fluid 136 surrounds all or part of the optical scanning element 118 such that the light-transmissive fluid is present in multiple (e.g., all) optical paths to which optical scanning element 118 can direct light output or receive reflected light input.

The light-transmissive fluid 136 may be or include oil, such as silicon oil. The light-transmissive fluid may be clear or substantially clear. For example, the light-transmissive fluid may have a clarity of 90%, 91%, 92%, 93%, 94% 95%, 96%, 97%, 98%, 99%, or more, where the percentage of clarity is defined by the percentage of incident light that passes through the fluid instead of being absorbed by the fluid. The light-transmissive fluid also has the same, or substantially the same, optical index as flat window 135. For example, the two optical indices may be within 10% of each other, 9% of each other, 8% of each other, 7% of each other, 6% of each other, 5% of each other, 4% of each other, 3% of each other, 2% of each other, 1% of each other, or less. In an example, flat window 135 made of N-BK7 glass has an optical index of 1.4 and, which is within 5% of the optical index of silicon oil. In another example, clear plastic has a similar optical index of 1.48. The optical index of air in the environment 140 exterior to enclosure 130 is 1.0. Light bending occurs due to differences in optical indices at the flat window 135/air 140 interface. There are reduced or no reflections at flat window 135 during some operation, since within enclosure 130, the optical index of flat window 135 is the same as, or substantially the same as, the optical index of light-transmissive fluid 136. That is, absent light-transmissive fluid 136, there would be air, which would cause reflections at window 135 internal to enclosure 130.

Optical scanning element 118 may be made of glass having an optical index of 1.8 or greater. In some implementations, there is a 0.4 differential between the light-transmissive fluid 136 and the optical scanning element 118. This differential in optical indices promotes bending of light between the optical scanning element and the light-transmissive fluid, thereby providing a potentially greater scanning field-of-view when combined with light bending at the flat window/air interface.

FIG. 3 also shows multiple light beams 134 that were output at different times by optical scanning element 118 or that were reflected from an object in the environment. As shown, light 134 bends upon entry or exit of enclosure 130 at an angle, with more pronounced bending occurring towards the edges, such as edge 144, of enclosure 130, thereby enabling a wider range of scanning. Light 134a closer to the center of flat window 135 bends less, passing straight through flat window 135 (that is, not at an angle) or bending little at the center of flat window 135. Any reflections that occur, for example, from light 134b entering or exiting enclosure 130 from behind, that is, from/to mirror 114 may be compensated for through control over operation—for example, movement of—of mirror 114 and/or optical scanning element 118.

In some implementations, flat window 135 may have an anti-reflective coating on its interior and/or exterior. The anti-reflective coating may further reduce reflections that occur from light encountering the flat window. The anti-reflective coating may be or include one or more thin layers of oxides, metals, or rare earth metals that change the optical properties of the flat window in order to reduce reflections.

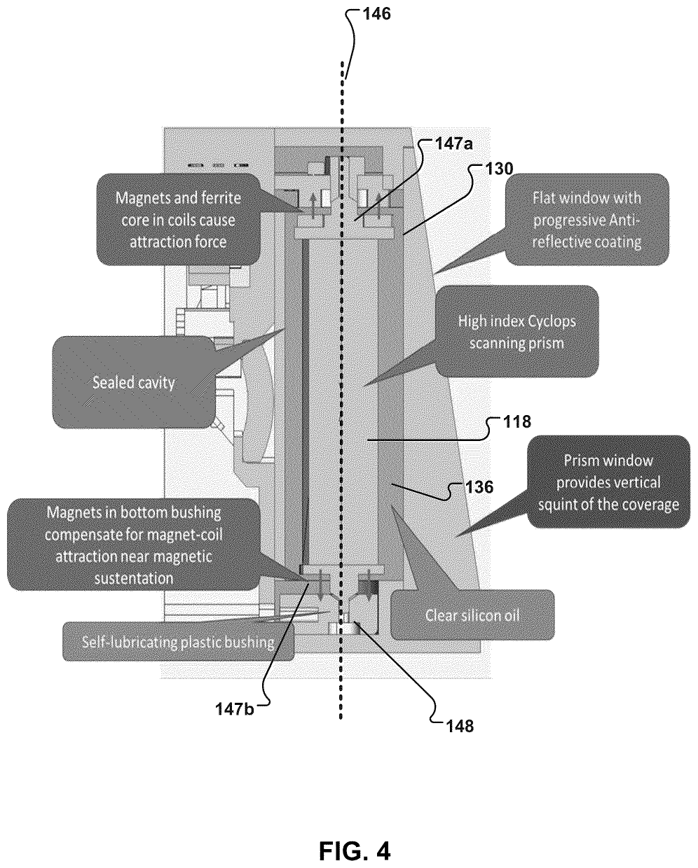

FIG. 4 shows components of optical scanning element 118 within enclosure 130 containing light-transmissive fluid 136 and having an anti-reflective coating. In this example, optical scanning element 118 is mounted for rotation about its longitudinal axis 146. Optical scanning element 118 includes one or more coils and one or more magnets 147a, at its top and one or more magnets 147b at its bottom to suspend the optical scanning element magnetically within the light-transmission fluid 136 through magnetic sustentation, Current applied to the coils may produce a magnetic field that interacts with the magnetic field of the nearby magnet(s) to enable rotation of optical scanning element 118. Optical scanning element 118 also includes a plastic bushing 148 at a bottom thereof to enable its rotation. The light-transmissive fluid 136, such as oil, may lubricate the moving parts of the optical scanning element. During operation, a brushless motor (not shown) controlled by control system 132 may control which coil(s) are energized in order to produce rotation of the optical scanning element.

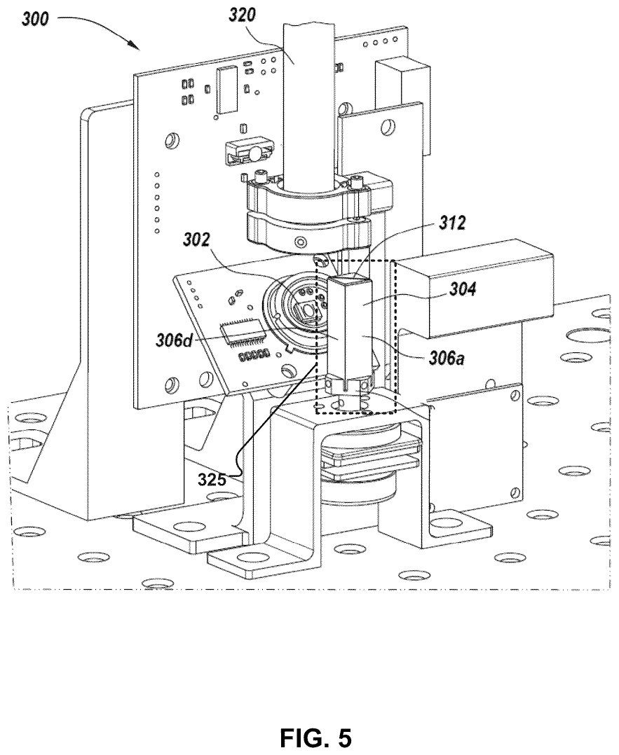

FIG. 5 shows a front perspective view of components of an example detection system 300, which may be the same as, or include the same components as, detection system 100 (FIG. 2). The optical path between the emitter and detector and the reflective mirror 302 can run through collimating lens 320, with the reflective mirror 302, and optical scanning element 304 positioned in alignment with respect to the azimuth plane (although not necessarily at a shared elevation), providing a compact system while still allowing for a significant scanning range in the azimuth and elevation directions. Optical scanning element 304 is contained within enclosure 325 containing light-transmissive fluid, as described herein. As with other detection systems shown and described herein, after reflecting off the reflective mirror 302, which can oscillate to change the field of view of the system in the elevation direction, the light beams interact with the optical scanning element 304 before entering the surrounding environment.

FIGS. 6A and 6B show an example implementation of optical scanning element 304, which may be the same as optical scanning element 118. The optical scanning element, however, is not limited to the shapes shown in FIGS. 6A and 6B. In this example, optical scanning element 304 has a glass body in the shape of a rectangular prism with an exterior defined by four outer glass faces 306a, 306b, 306c, 306d (generally 306) forming the prism sides which extend between the glass faces 310a, 310b (generally 310) which form the prism ends. In general, the faces 306 are at right angles to one another. The outer faces 306 are generally transmissive, allowing light to pass therethrough, and allowing light to pass through the glass body of the optical element 304, while redirecting the light as described herein.

A flat rectangular reflective member 312 having opposing reflective surfaces 308a, 308b forms a diagonal cross section of the optical element 304. The reflective member 312 extends the length of the optical scanning element 304 between the ends 310, running parallel to the outer faces 306. In particular, two of the transmissive faces 306b, 306c are on a first side 308a of the reflective member 312, light passing through those transmissive faces 306b, 306c interacting with the first side 308a. In effect, the sides 306b, 306c form an isosceles right triangular prism with the first side 308a of the reflective member 312 and with the reflective member 312 being the hypotenuse. Similarly other two transmissive faces 306a, 306d are on a second side 308b of the reflective member 312, allowing light passing through to interact with the second side 308b of the reflective member 312. The transmissive faces 306a, 306d likewise form an isosceles right triangular prism with the second side 308b of the reflective member 312 and with the reflective member 312 being the hypotenuse.

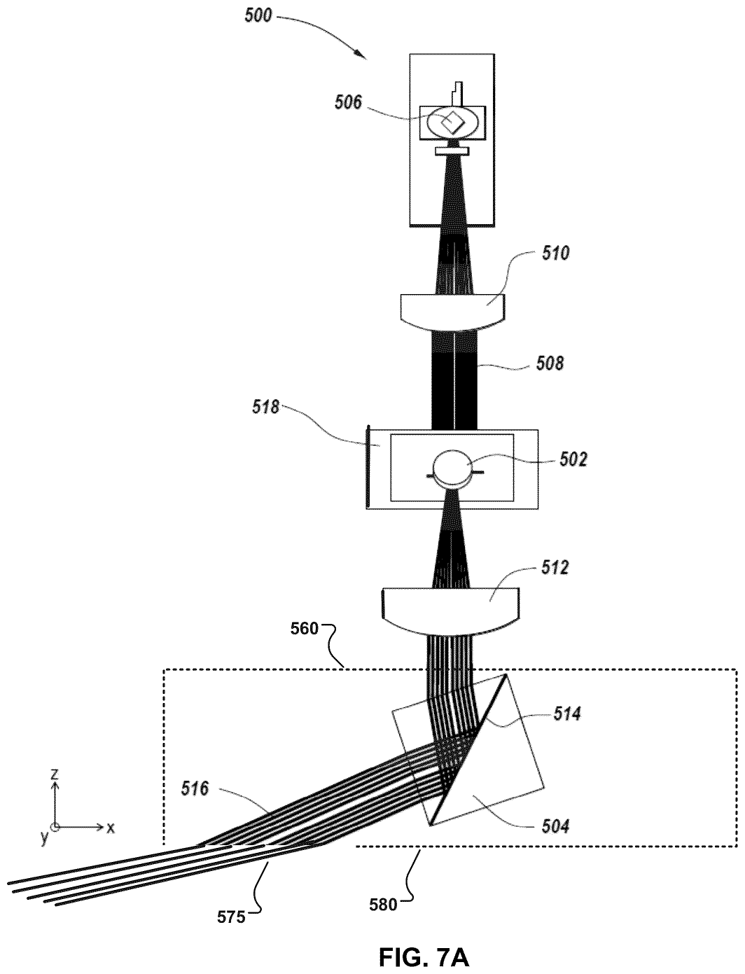

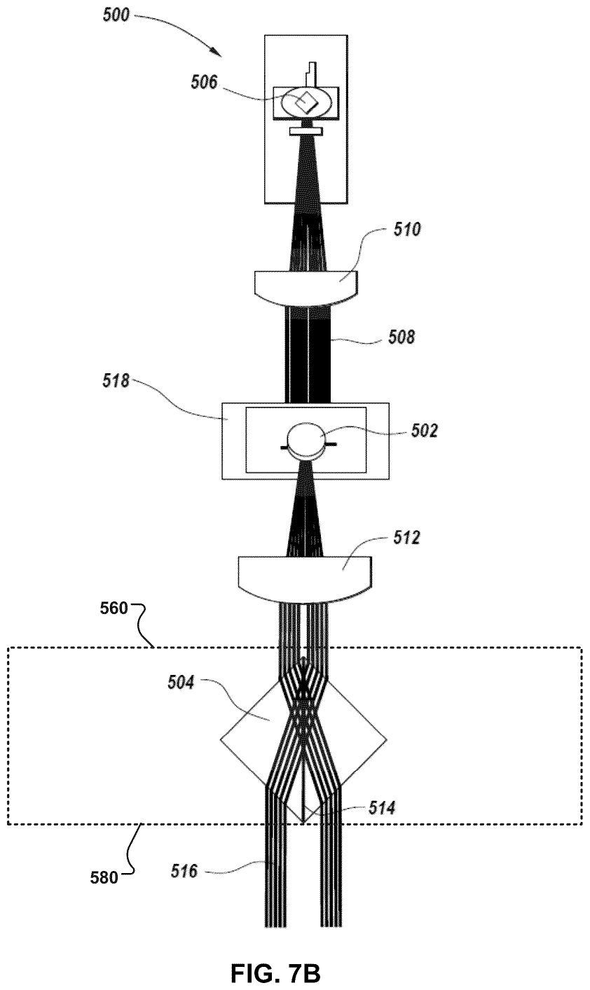

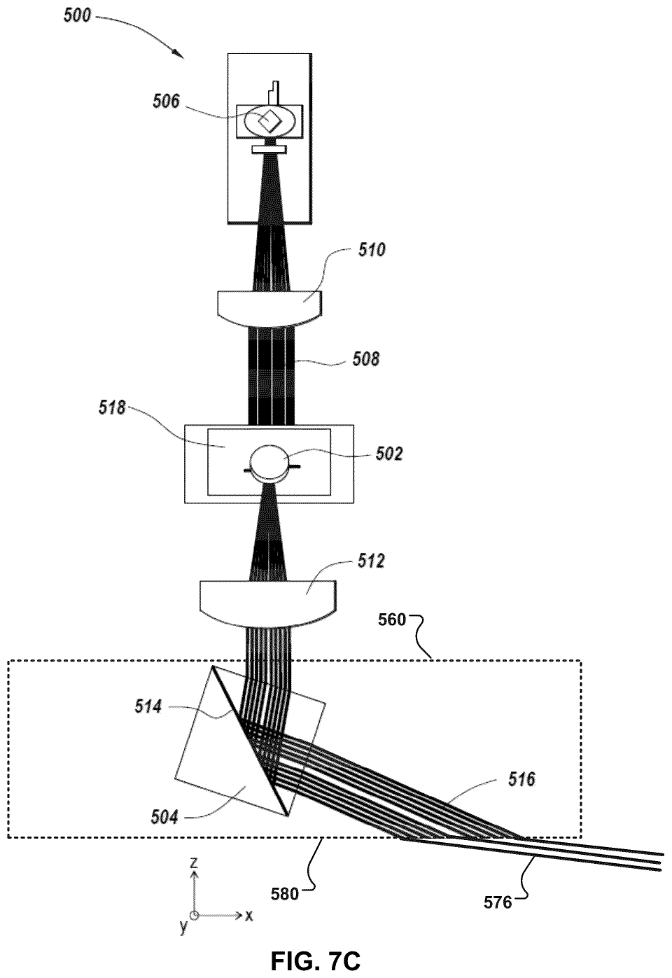

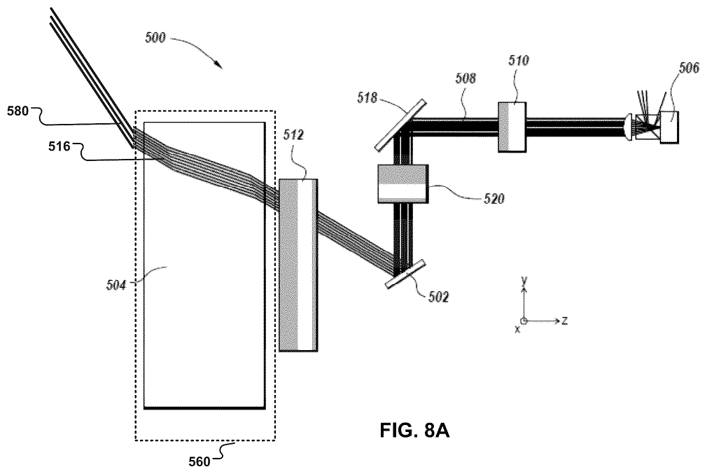

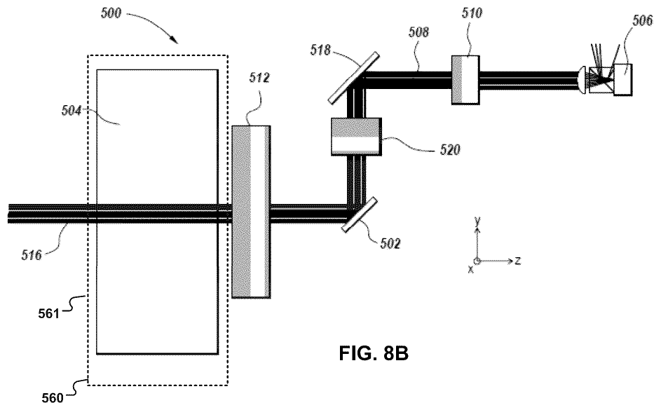

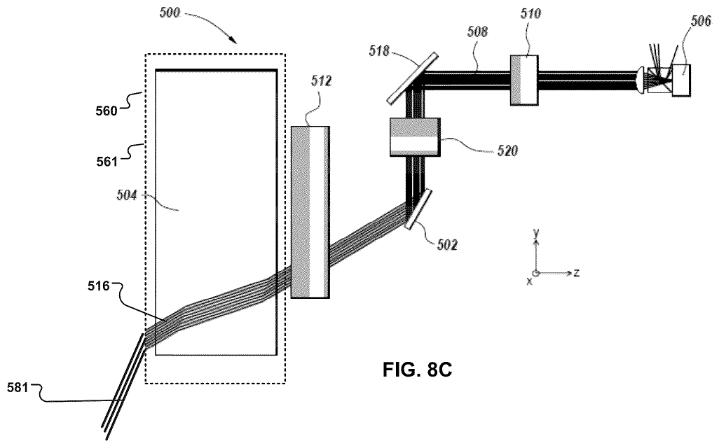

Referring to FIGS. 7A to 8C, schematic diagrams of an example detection system 500 are shown. Detection system 500 may include components having the same structure and function as detection systems 100 and 300. FIGS. 7A to 7C show an example scanning pattern of system 500 over an azimuth sweep, while FIGS. 8A to 8C show an example scanning pattern over an elevation sweep.

FIGS. 7A to 7C show overhead views of an example scanning pattern that can be produced by the detection system 500. In the arrangement shown, the reflective mirror 502, optical scanning element 504, and the LIDAR system 506 (including LIDAR transmitters and receivers, as well as other necessary LIDAR components) are arranged in substantially a straight line in the azimuth plane (understanding there might be a slight offset of some LIDAR system 506 components, for example, as shown when the beam splitter 110 of FIG. 2 is used). In this example, the optical path 508 forms a straight line between the LIDAR transmitters of the LIDAR system 506, the reflective mirror 502, and the optical scanning element 504. A first collimating lens 510 is included between the LIDAR system 506 and the reflective mirror 502 and a second collimating lens 512 is included between the reflective mirror 502 and the optical scanning element 504. A third collimating lens 520 is also located between the reflective mirror 502 and a folding mirror 518, as seen in FIGS. 8A to 8C. Optical scanning element 504 is contained within liquid-tight enclosure 560 and is wholly or partially submerged in light-transmissive fluid, such as silicon oil. The configuration may of optical scanning element 504 within enclosure may be as shown in FIG. 4.

FIG. 7A shows reflective member 514 included in optical scanning element at an angle of −35 degrees relative to optical path 508, with the transmitted and returning light beams 516 continuing to reflect off a surface of the reflective member 514. As noted, optical scanning element 504 is included in enclosure 560 like that of FIG. 4 and submerged, in whole or in part, within a light-transmissive fluid, such as silicon oil. This configuration reduces light reflections and produces the additional bending 575 of light beams 516 at the enclosure (flat window)/air interface 580. At the position shown in FIG. 7B, the system 500 is scanning directly ahead. The optical element 504 has rotated such that the flat reflective faces of the reflective member 514 are parallel to the optical path 508 of the transmitted and returning light beams 516. In this position, the glass body of the optical scanning element 504 helps redirect light around the reflective member 514 so that it does not interfere with the transmission and receipt of light beams 516. There is little or no bending at the enclosure (flat window)/air interface 580, as shown. FIG. 7C shows the scanning pattern as the optical scanning element 504 turns in the other direction (i.e. shown at the opposite angle of FIG. 7A). In FIG. 7C, the reflective member 514 is at an angle of +35 degrees and the transmitted and returning light beams 516 scan the other side of the vehicle, as compared to FIG. 7A. This configuration reduces light reflections and produces the additional bending 576 of light beams 516 at the enclosure (flat window)/air interface 580. A greater field of view than that shown in FIGS. 7A to 7C is achievable using the components of system 500.

Referring now to FIGS. 8A to 8C, while an azimuth scan is conducted as shown in FIG. 7A to 7C, or without an azimuth scan, an elevation scan may be conducted. The azimuth scan may be controlled by rotation of the optical scanning element 504, while the elevation scan may be controlled by oscillation of the reflective mirror 502, although it should be understood that these roles could be reversed in other embodiments. Moving mirror 502 and optical scanning element 504 enables combined azimuth and elevation scanning. The optical scanning element is included in an enclosure 560 like that of FIG. 4 and submerged, in whole or in part, in a light-transmissive fluid, such as silicon oil. Although the positions of the LIDAR system 506, reflective mirror 502, and optical scanning element 504 are aligned in the azimuth plane, the LIDAR system 506 is at a different elevation (e.g., different position along the y axis) from the reflective mirror 502 and the optical scanning element 504 which are centered at the same elevation. The folding mirror 518 makes this positioning possible, as it is placed directly above the scanning mirror 502 to redirect transmitted light beams 516 from the LIDAR system 506 through the lens 520 and to the scanning mirror 502. Thus, the LIDAR system 506 can be placed behind the scanning mirror 502 in the azimuth direction and the light beams still reflect off the scanning mirror 502 to the optical scanning element 504.

For explanatory purposes, FIG. 88 will be described as having reflective mirror 502 at an angle of 0 degrees, representing a scan angle at the same elevation as the boresight of the detection system 500. FIG. 8A depicts a scan position where the reflective mirror has oscillated to an angle of −15 degrees to obtain a maximum scan angle upwards in the elevation direction, while FIG. 8C depicts a scan position where the reflective mirror 502 has oscillated to an angle of 15 degrees to obtain a maximum scan angle downwards in the elevation direction. The enclosure and light-transmissive fluid reduces light reflections and produces the additional bending 580 (FIG. 8A) and 581 (FIG. 8C) of light beams 516 at the enclosure (flat window)/air interface 561. The enclosure and light-transmissive fluid also reduce reflections, as described herein.

Signals obtained via the LIDAR system may be used by the control system to control and/or to inform various automobile operations including, but not limited to, automatic emergency braking for the automobile, forward sensing for the automobile, or automated/self-driving for the automobile. For example, if an object is detected in the automobile's path of travel, the vehicles brakes may be activated, or the steering of the automobile may be controlled to avoid the object, as described below

The implementations of the LIDAR system described herein may have a FOV of approximately 50°×10° and may reliably detect 10% reflective objects at a 40 meter (me) distance in full sunlight. These numbers, however are examples only and are not limiting. For example, the range of the system can be increased by scaling the optics.

The example systems described herein may be controlled by a control system, such as control system 132 of FIG. 2, to control all or part of the operation of the LIDAR system 100, 300, 500 components. The control system may be part of an onboard control system on the automobile. As shown in FIG. 2, in some implementations, an onboard portion 70 of control system 132 includes one or more processing devices 71 of the type described herein that are programmable to control operations of at least some of the components of the system. The onboard portion 70 of control system 132 may also include memory 74 for storing data and programs executable by the one or more processing devices 71 to implement all or part of the functionality described herein. The control system 132 may also include an external computing system 72 that communicates to the onboard control portion 70. For example, the external computing system 72 may communicate with the onboard control portion 70 using a cellular network or other appropriate wireless functionality. Control module 120 may communicate with control system 132 or be part thereof. In an example, control system 132 communicates instructions to control module 120, which executes those instructions to control the LIDAR system components. Control module 120 communicates data from the LIDAR system to control system 132, where that data may be processed to control operation of the automobile.

Although the preceding descriptions focus on using LIDAR on a vehicle's front-end, LIDAR may be incorporated on the back-end of a vehicle to perform scanning using to the techniques described herein. Furthermore, the systems and techniques are not limited to use with front- and back-ends, but rather may be incorporated at any appropriate location on a vehicle, including its sides. Still further, the systems and techniques are not limited to use with automobiles, but rather may be used with any type of vehicle, whether operator-drive or automated.

All or part of the systems and processes described in this specification and their various modifications may be configured or controlled at least in part by one or more computing systems, such as control system 132, using one or more computer programs tangibly embodied in one or more information carriers, such as in one or more non-transitory machine-readable storage media A computer program can be written in any form of programming language, including compiled or interpreted languages, and it can be deployed in any form, including as a stand-alone program or as a module, part, subroutine, or other unit suitable for use in a computing environment. A computer program can be deployed to be executed on one computer or on multiple computers at one site or distributed across multiple sites and interconnected by a network.

Actions associated with configuring or controlling the systems and processes described herein can be performed by one or more programmable processors executing one or more computer programs to control or to perform all or some of the operations described herein. All or part of the systems and processes can be configured or controlled by special purpose logic circuitry, such as, an FPGA (field programmable gate array) and/or an ASIC (application-specific integrated circuit) or embedded microprocessor(s) localized to the instrument hardware.

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer include one or more processors for executing instructions and one or more storage area devices for storing instructions and data. Generally, a computer will also include, or be operatively coupled to receive data from, or transfer data to, or both, one or more machine-readable storage media, such as mass storage devices for storing data, such as magnetic, magneto-optical disks, or optical disks, Non-transitory machine-readable storage media suitable for embodying computer program instructions and data include all forms of non-volatile storage area, including by way of example, semiconductor storage area devices, such as EPROM (erasable programmable read-only memory), EEPROM (electrically erasable programmable read-only memory), and flash storage area devices; magnetic disks, such as internal hard disks or removable disks; magneto-optical disks; and CD-ROM (compact disc read-only memory) and DVD-ROM (digital versatile disc read-only memory).

Elements of different implementations described may be combined to form other implementations not specifically set forth previously. Elements may be left out of the systems described previously without adversely affecting their operation or the operation of the system in general. Furthermore, various separate elements may be combined into one or more individual elements to perform the functions described in this specification.

Other implementations not specifically described in this specification are also within the scope of the following claims.

What is claimed is:

1. A system comprising:
a movable optical element configured to direct light along an optical path;
a flat surface along the optical path, the light from the movable optical element passing through the flat surface to an external environment; and
a light-transmissive fluid that is present along the optical path, the light-transmissive fluid and the flat surface having a substantially same optical index.

2. The system of claim 1, further comprising:
a light source to emit the light; and
one or more static optical element to direct the light along an initial optical path;
wherein the movable optical element is configured to receive the light from the initial optical path and to redirect the light along optical path.

3. The system of claim 1, wherein the external environment has an optical index that is less than the optical index of the light-transmissive fluid and the flat surface.

4. The system of claim 3, wherein the movable optical element has an optical index that is greater than the optical index of the light-transmissive fluid and the flat surface.

5. The system of claim 4, wherein the movable optical element has an optical index that is 0.4 or more greater than the optical index of the light-transmissive fluid and the flat surface.

6. The system of claim 1, wherein the wherein the light-transmissive fluid comprises oil.

7. The system of claim 6, wherein the light-transmissive fluid comprises silicon oil.

8. The system of claim 1, wherein the light-transmissive fluid has a light transmissibility of 95% or more.

9. The system of claim 1, wherein the flat surface comprises glass.

10. The system of claim 1, wherein the flat surface comprises at least one of polycarbonate, polymer, or clear acrylic.

11. The system of claim 1, wherein the movable optical element comprises an optical scanning element having a glass body in the shape of a rectangular prism, wherein the optical scanning element is configured to rotate around an axis, and wherein the optical scanning element comprises a reflective member having opposing reflective surfaces within the glass body.

12. The system of claim 11, wherein the optical scanning element comprises one or more magnets; and
wherein the system comprises coils that are controllable to generate one or more magnetic fields that interact with the one or more magnets to control rotation of the optical scanning element.

13. The system of claim 1, wherein the movable optical element is configured to receive the light from an initial optical path at a first side thereof and to redirect the light along the optical path from a second side thereof, the first side being behind the second side.

14. The system of claim 1, which is part of a light detection and ranging (LIDAR) system for a vehicle.

15. The system of claim 13, wherein the LIDAR system is configured for use in at least one of: automatic emergency breaking for the vehicle, forward sensing for the vehicle, or automated driving for the vehicle.

16. The system of claim 1, wherein the flat surface comprises an anti-reflective coating.

17. The system of claim 1, wherein the movable optical element is completely submerged in the light-transmissive fluid.

18. The system of claim 1, wherein the movable optical element is partially submerged in the light-transmissive fluid.

19. The system of claim 1, wherein the movable optical element is configured to direct light along multiple optical paths; and
wherein the light-transmissive fluid is present along the multiple optical paths.

20. The system of claim 1, wherein the external environment comprises air.
